(19) United States
(12) Patent Application Publication
(10) Pub. No.: US 2025/0070570 A1
(43) Pub. Date: Feb. 27, 2025

(54) ELECTRONICS CHARGING STATION APPARATUS

(71) Applicant: Oscillious Kemp, Duncanville, TX (US)

(72) Inventor: Oscillious Kemp, Duncanville, TX (US)

(21) Appl. No.: 18/236,724

(22) Filed: Aug. 22, 2023

(51) Int. Cl. H02J 7/00; H02J 7/02; H02J 50/10

(52) U.S. Cl. CPC H02J 7/0013; H02J 7/00047; H02J 7/0042; H02J 7/0048; H02J 7/02; H02J 50/10

(57) ABSTRACT

A charging station apparatus for simultaneously charging multiple electronic devices includes a body containing circuitry. A power input port and a plurality of power outlets are coupled to the body and are electrically coupled to the circuitry. The plurality of power outlets includes a plurality of alternating current power outlets and a plurality of direct current power outlets. Power banks are removably positionable in slots of the body and electrically couple to the circuitry when positioned in the slots. The power banks each have charging circuits for charging the electronic devices.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electronics charging apparatuses and more particularly pertains to a new electronics charging apparatus for simultaneously charging multiple electronic devices.

### (2) Description of Related Art Including Information Disclosed Under 37 CFR 1.97 and 1.98

The prior art describes myriad electronics charging apparatuses. However, the prior art fails to disclose such an apparatus which draws power from a single alternating current power source and delivers it to multiple alternating current outlets, multiple direct current outlets, and multiple removable power banks which are configured for charging electronic devices. Such an apparatus would provide increased versatility over the devices of the prior art to charge electronic devices simultaneously and, via the removable power banks, remotely from each other.

### BRIEF SUMMARY OF THE INVENTION

An embodiment of the disclosure meets the needs presented above by generally comprising a body with circuitry mounted therein. A power input port and a plurality of power outlets are coupled to the body and are electrically coupled to the circuitry. The plurality of power outlets includes a plurality of alternating current (AC) power outlets, and the circuitry is configured to direct AC power from the power input port to each AC power outlet of the plurality of AC power outlets. The plurality of power outlets includes a plurality of direct current (DC) power outlets, and the circuitry is configured to transform the AC power into DC power and direct the DC power to each DC power outlet of the plurality of DC power outlets.

The body has a slot extending therein, and a power bank is removably positionable in the slot of the body. The power bank comprises a housing, a battery mounted in the housing, and a charging circuit. The charging circuit is mounted in the housing and is electrically coupled to the battery. The charging circuit is configured to electrically charge a personal electronic device.

An electrical connector comprises a first mating member and a second mating member. The first mating member is positioned in the slot of the body and is electrically coupled to the circuitry, and the second mating member is coupled to the power bank and is electrically coupled to the battery of the power bank. The first mating member and the second mating member are electrically coupled together when the power bank is positioned in the slot. The circuitry is configured to transform the AC power into DC power and direct the DC power to each connector to charge the battery of the power bank when the power bank is positioned in the slot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a charging station apparatus according to an embodiment of the disclosure.

FIG. 2 is a front view of an embodiment of the disclosure.

FIG. 3 is a bottom view of an embodiment of the disclosure.

FIG. 4 is a rear view of an embodiment of the disclosure.

FIG. 5 is a cross-section view of an embodiment of the disclosure taken from Arrows 5-5 in FIG. 4.

FIG. 6 is an exploded perspective view of an embodiment of the disclosure.

FIG. 7 is a detail in-use view of a power bank charging a personal electronic device of an embodiment of the disclosure.

FIG. 8 is an in-use view of an embodiment of the disclosure.

FIG. 9 is a perspective view of an embodiment of the disclosure in a storage case.

FIG. 10 is a block diagram of an embodiment of the disclosure.

### DETAILED DESCRIPTION OF THE INVENTION

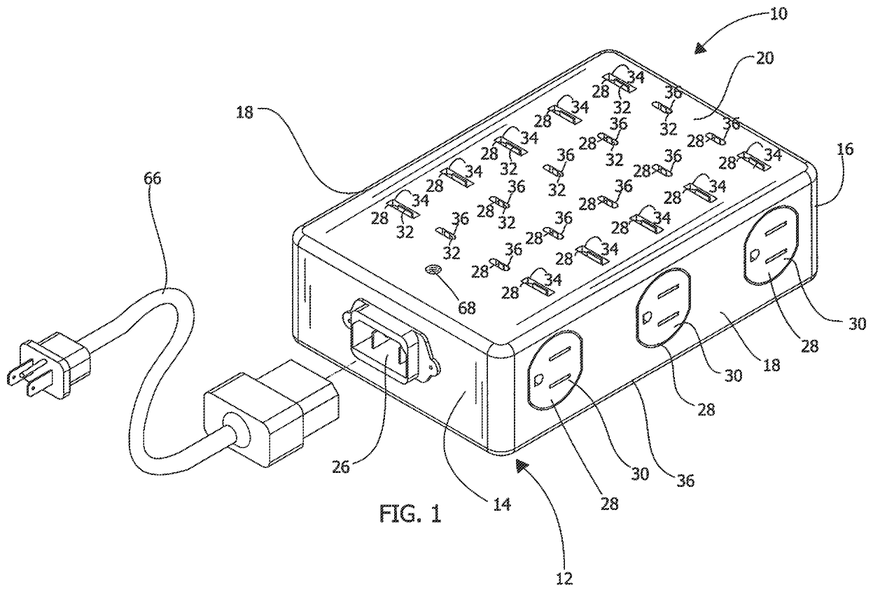

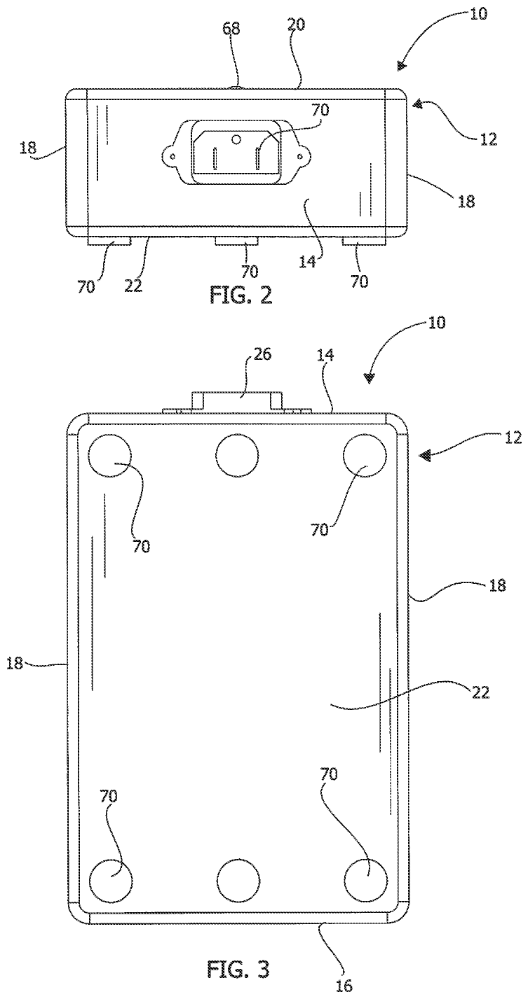

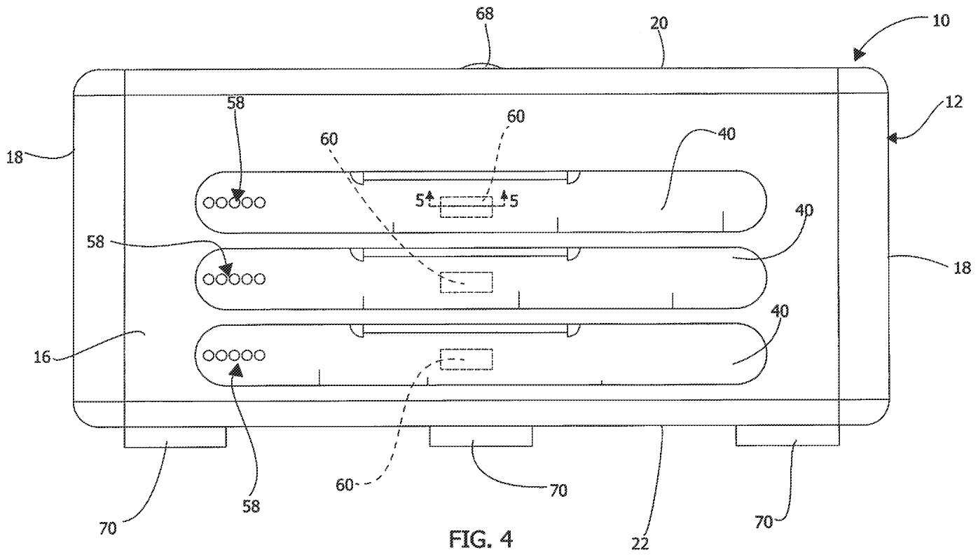

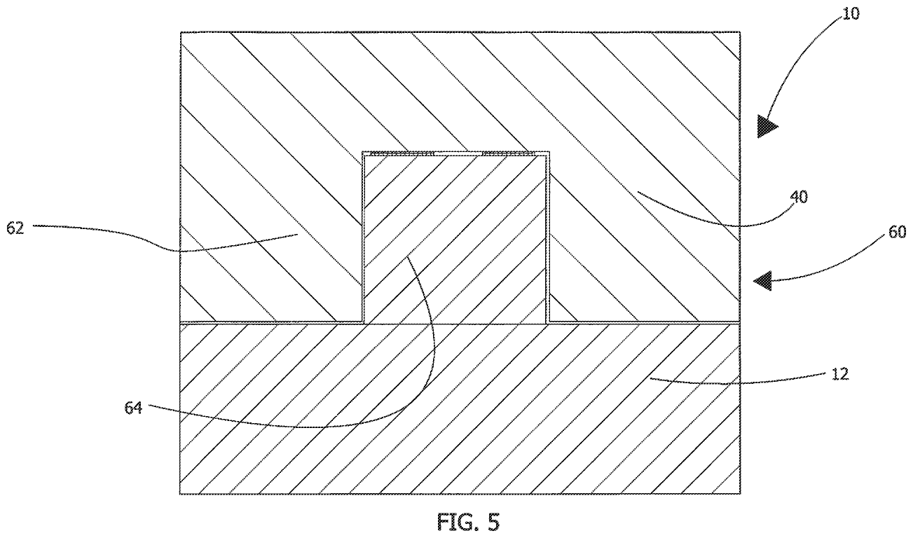

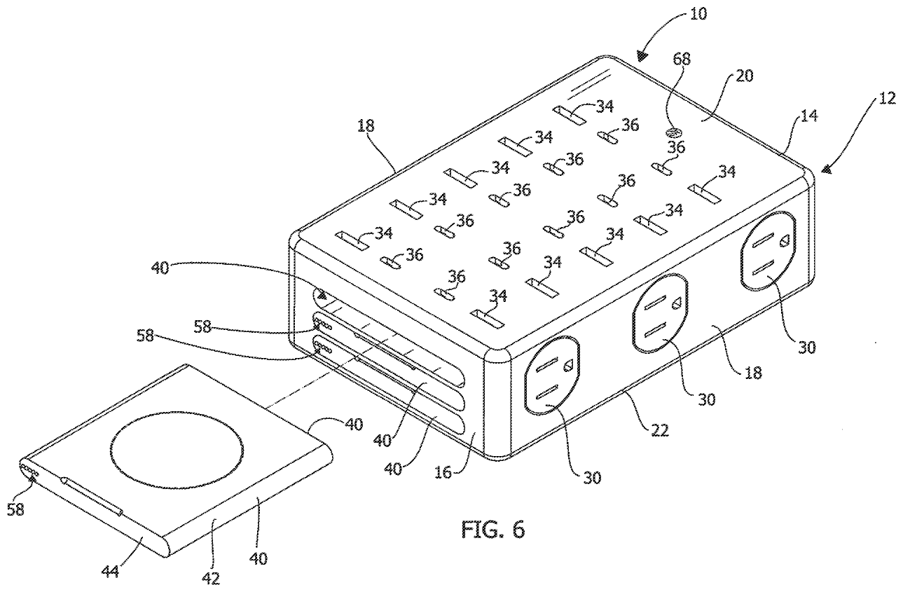

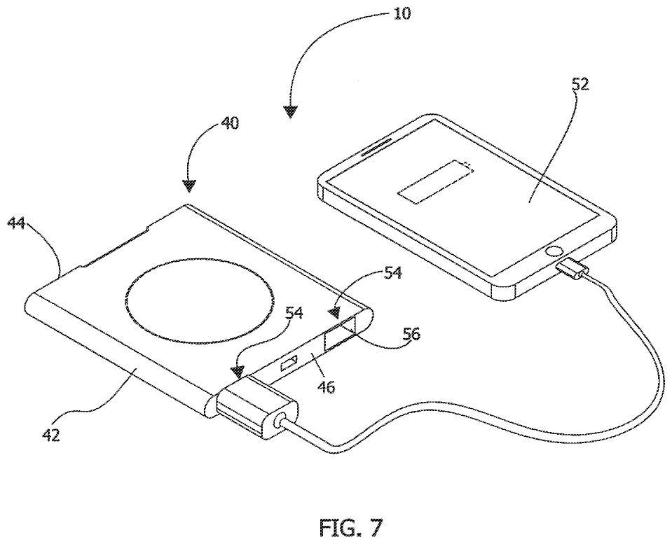

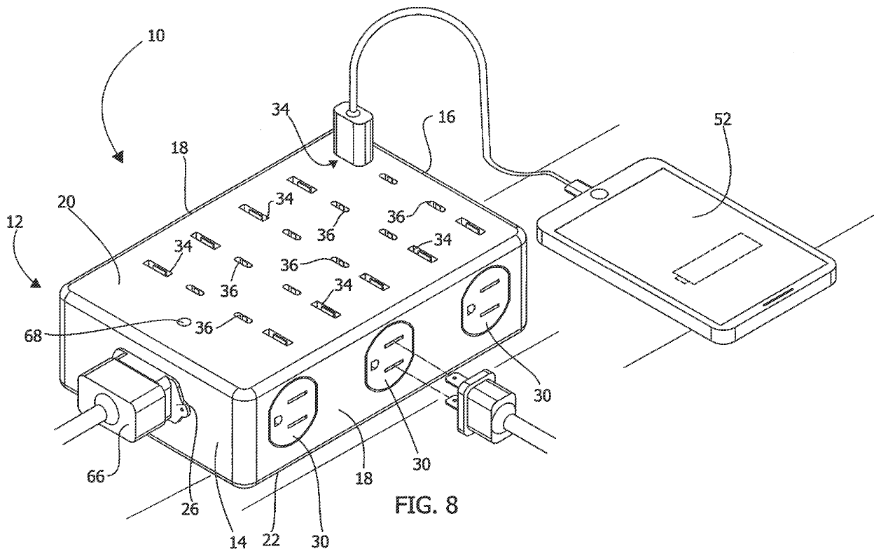

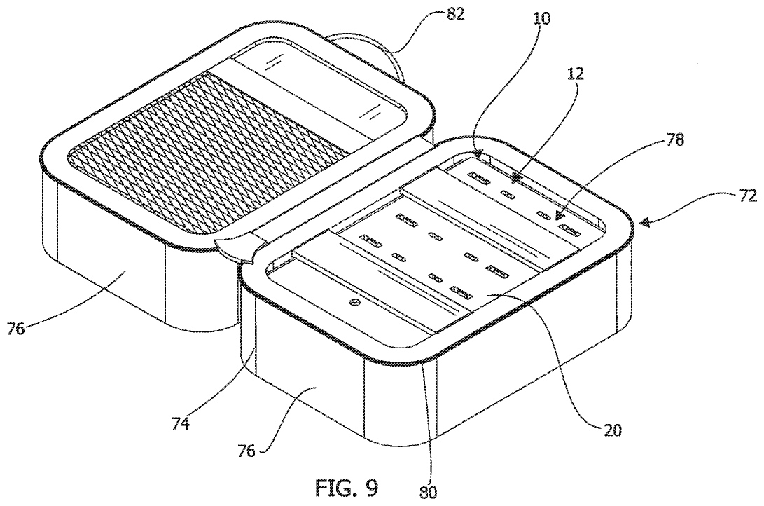

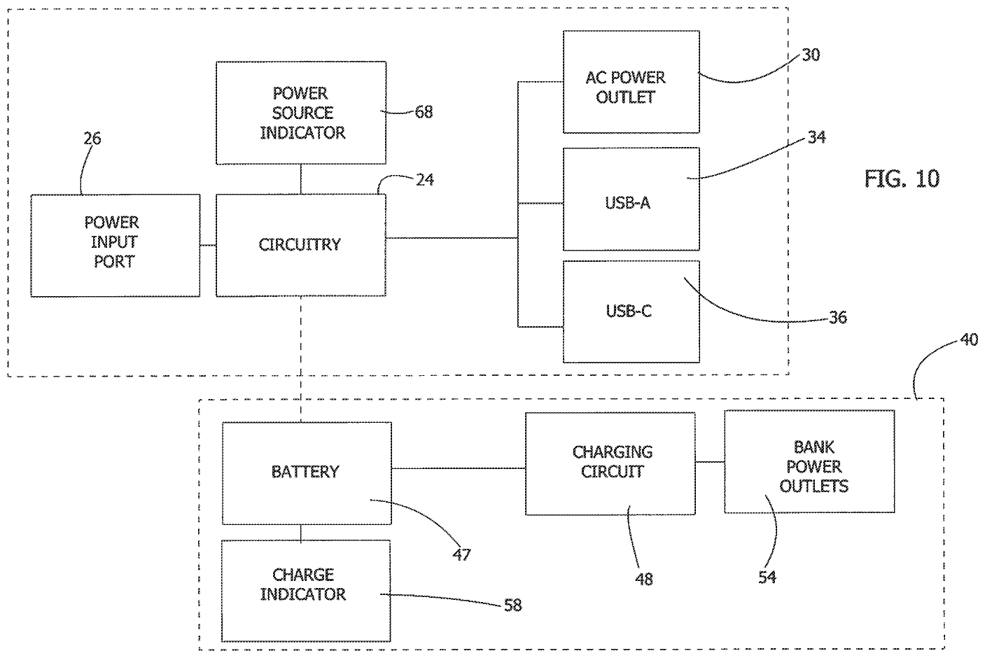

With reference now to the drawings, and in particular to FIGS. 1 through 6 thereof, a new electronics charging apparatus embodying the principles and concepts of an embodiment of the disclosure and generally designated by the reference numeral 10 will be described.

As best illustrated in FIGS. 1 through 6, the charging station apparatus 10 generally comprises a body 12 with a front side 14, a rear side 16, a pair of lateral sides 18, a top side 20, and a bottom side 22. The pair of lateral sides 18 extend between the front side 14 and the rear side 16. The top side 20 and the bottom side 22 each extend between the front side 14 and the rear side 16 and between the pair of lateral sides 18. Circuitry 24 is mounted in the body 12. A power input port 26 is coupled to the body 12 and is electrically coupled to the circuitry 24. The power input port 26 is positioned on the front side 14 of the body 12. A plurality of feet 70 is attached to the bottom side 22 of the body 12 to support the body 12 on a support surface. Each foot 70 of the plurality of feet 70 may comprise rubber or a like material.

A plurality of power outlets 28 is coupled to the body 12 and is electrically coupled to the circuitry 24. The plurality of power outlets 28 includes a plurality of alternating current (AC) power outlets 30, and the circuitry 24 is configured to direct AC power from the power input port 26 to each AC power outlet 30 of the plurality of AC power outlets 30. Each AC power outlet 30 of the plurality of AC power outlets 30 is positioned on an associated one of the pair of lateral sides 18 of the body 12. The plurality of power outlets 28 also includes a plurality of direct current (DC) power outlets 32, and the circuitry 24 is configured to transform the AC power into DC power and direct the DC power to each DC power outlet 32 of the plurality of DC power outlets 32. The plurality of DC power outlets 32 includes a plurality of universal serial bus type-A (USB-A) ports 34 and a plurality of universal serial bus type-C (USB-C) ports 36. The plurality of DC power outlets 32 also may include other conventional outlet ports for transferring DC power. The plurality of DC power outlets 32 is positioned on the top side 20 of the body 12.

The body 12 has a plurality of slots 38 extending therein through the rear side 16. Each power bank 40 of a plurality of power banks 40 is removably positionable in an associated slot 38 of the plurality of slots 38 of the body 12. Each power bank 40 of the plurality of power banks 40 comprises a housing 42, a battery 47, and a charging circuit 48. The housing 42 is complementary in shape to the associated slot 38, has a first side 44 which faces away from the body 12 when the housing 42 is positioned in the associated slot 38, and has a second side 46 opposite the first side 44. The battery 47 is mounted in the housing 42, and the charging circuit 48 is mounted in the housing 42 and is electrically coupled to the battery 47. The charging circuit 48 includes a wireless charging circuit 50 which is configured to wirelessly charge a personal electronic device 52 when the personal electronic device 52 inductively couples to the wireless charging circuit 50.

Each power bank 40 of the plurality of power banks 40 further comprises a pair of bank power outlets 54 which is coupled to the housing 42 and is electrically coupled to the charging circuit 48. Each bank power outlet 54 of the pair of bank power outlets 54 comprises a bank USB-A port 56 but may comprise another conventional outlet port for transferring DC power. The pair of bank power outlets 54 is positioned on the second side 46 of the housing 42. A charge indicator 58 is electrically coupled to the battery 47 and is positioned on the first side 44 of the housing 42. The charge indicator 58 is configured to indicate a level of charge of the battery 47 and may comprise, for example, a light emitter.

Each electrical connector 60 of a plurality of electrical connectors 60 comprises a first mating member 62 and a second mating member 64. The first mating member 62 is positioned in an associated slot 38 of the plurality of slots 38 and is electrically coupled to the circuitry 24. The second mating member 64 is coupled to an associated power bank 40 of the plurality of power banks 40 and is electrically coupled to the battery 47 of the associated power bank 40. The second mating member 64 is positioned on the second side 46 of the housing 42 of the associated power bank 40. The first mating member 62 and the second mating member 64 are electrically coupled together when the associated power bank 40 is positioned in the associated slot 38. The circuitry 24 is configured to transform the AC power into DC power and direct the DC power to each connector to charge the battery 47 of the associated power bank 40 when the associated power bank 40 is positioned in the associated slot 38.

A power cord 66 is electrically couplable to the power input port 26 and is configured to couple to an AC power source. A power source indicator 68 is coupled to the body 12 and is electrically coupled to the circuitry 24. The power source indicator 68 is configured to indicate when the AC power is being supplied to the circuitry 24. The power source indicator 68 may comprise, for example, a light emitter.

A storage case 72 may be provided to contain and transport the charging station apparatus 10. The storage case 72 may have a clamshell shape 74 comprising a pair of sections 76, wherein the sections 76 of the pair of sections 76 are pivotally coupled to each other. One section 76 of the pair of sections 76 may define a cavity 78 for containing the charging station apparatus 10. A closure 80 comprising a zipper or like fastener may be provided to join the pair of sections 76 of the clamshell shape 74 and close the cavity 78. A handle 82 may be provided for carrying the storage case 72.

In use, electronic devices may be charged by electrically coupling to one of the plurality of power outlets 28 or to one of the plurality of power banks 40. The batteries of the plurality of power banks 40 may be charged and the plurality of power banks 40 may be stored by placing the plurality of power banks 40 into the plurality of slots 38 of the body 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A charging station apparatus comprising:
a body, the body having a slot extending therein;
circuitry being mounted in the body;
a power input port being coupled to the body and being electrically coupled to the circuitry;
a plurality of power outlets being coupled to the body and being electrically coupled to the circuitry, the plurality of power outlets including a plurality of alternating current (AC) power outlets, the circuitry being configured to direct AC power from the power input port to each AC power outlet of the plurality of AC power outlets, the plurality of power outlets including a plurality of direct current (DC) power outlets, the circuitry being configured to transform the AC power into DC power and direct the DC power to each DC power outlet of the plurality of DC power outlets;
a power bank, the power bank being removably positionable in the slot of the body, the power bank comprising:
a housing;
a battery being mounted in the housing; and
a charging circuit being mounted in the housing and being electrically coupled to the battery, the charging circuit being configured to electrically charge a personal electronic device; and
an electrical connector, the electrical connector comprising a first mating member and a second mating member, the first mating member being positioned in the slot and being electrically coupled to the circuitry, the second mating member being coupled to the power bank and being electrically coupled to the battery of the power bank, the first mating member and the second mating member being electrically coupled together when the power bank is positioned in the slot, the circuitry being configured to transform the AC power into DC power and direct the DC power to each connector to charge the battery of the power bank when the power bank is positioned in the slot.

2. The apparatus of claim 1, wherein the plurality of DC power outlets includes a plurality of universal serial bus type-A (USB-A) ports.

3. The apparatus of claim 1, wherein the plurality of DC power outlets includes a plurality of universal serial bus type-C (USB-C) ports.

4. The apparatus of claim 1, wherein the housing is complementary in shape to the slot.

5. The apparatus of claim 1, wherein the charging circuit includes a wireless charging circuit, the wireless charging circuit being configured to wirelessly charge the personal electronic device when the personal electronic device inductively couples to the wireless charging circuit.

6. The apparatus of claim 1, wherein the power bank further comprises a bank power outlet being coupled to the housing and being electrically coupled to the charging circuit.

7. The apparatus of claim 6, wherein the bank power outlet of comprises a bank USB-A port.

8. The apparatus of claim 1, wherein the power bank further comprises a charge indicator being electrically coupled to the battery, the charger indicator being configured to indicate a level of charge of the battery.

9. The apparatus of claim 1, further comprising a power cord being electrically couplable to the power input port, the power cord being configured to couple to an AC power source.

10. The apparatus of claim 1, further comprising a power source indicator being coupled to the body and being electrically coupled to the circuitry, the power source indicator being configured to indicate when the AC power is being supplied to the circuitry.

11. A charging station apparatus comprising:
a body, the body having a front side and a rear side, the body having a pair of lateral sides extending between the front side and the rear side, the body having a top side and a bottom side, each of the top side and the bottom side extending between the front side and the rear side and between the pair of lateral sides, the body having a plurality of slots extending therein through the rear side;
circuitry being mounted in the body;
a power input port being coupled to the body and being electrically coupled to the circuitry, the power input port being positioned on the front side of the body;
a plurality of power outlets being coupled to the body and being electrically coupled to the circuitry, the plurality of power outlets including a plurality of alternating current (AC) power outlets, the circuitry being configured to direct AC power from the power input port to each AC power outlet of the plurality of AC power outlets, each AC power outlet of the plurality of AC power outlets being positioned on an associated one of the pair of lateral sides of the body, the plurality of power outlets including a plurality of direct current (DC) power outlets, the circuitry being configured to transform the AC power into DC power and direct the DC power to each DC power outlet of the plurality of DC power outlets, the plurality of DC power outlets including a plurality of universal serial bus type-A (USB-A) ports and a plurality of universal serial bus type-C (USB-C) ports, the plurality of DC power outlets being positioned on the top side of the body;
a plurality of power banks, each power bank being removably positionable in an associated slot of the plurality of slots of the body, each power bank of the plurality of power banks comprising:
a housing, the housing being complementary in shape to the associated slot, the housing having a first side which faces away from the body when the housing is positioned in the associated slot, the housing having a second side opposite the first side;
a battery being mounted in the housing;
a charging circuit being mounted in the housing and being electrically coupled to the battery, the charging circuit including a wireless charging circuit, the wireless charging circuit being configured to wirelessly charge a personal electronic device when the personal electronic device inductively couples to the wireless charging circuit;
a pair of bank power outlets being coupled to the housing and being electrically coupled to the charging circuit, each bank power outlet of the pair of bank power outlets comprising a bank USB-A port, the pair of bank power outlets being positioned on the second side of the housing; and
a charge indicator being electrically coupled to the battery and being positioned on the first side of the housing, the charger indicator being configured to indicate a level of charge of the battery;
a plurality of electrical connectors, each electrical connector of the plurality of electrical connectors comprising a first mating member and a second mating member, the first mating member being positioned in an associated slot of the plurality of slots and being electrically coupled to the circuitry, the second mating member being coupled to an associated power bank of the plurality of power banks and being electrically coupled to the battery of the associated power bank, the second mating member being positioned on the second side of the housing of the associated power bank, the first mating member and the second mating member being electrically coupled together when the associated power bank is positioned in the associated slot, the circuitry being configured to transform the AC power into DC power and direct the DC power to each connector to charge the battery of the associated power bank when the associated power bank is positioned in the associated slot;
a power cord being electrically couplable to the power input port, the power cord being configured to couple to an AC power source; and
a power source indicator being coupled to the body and being electrically coupled to the circuitry, the power source indicator being configured to indicate when the AC power is being supplied to the circuitry.
